(19) United States
(12) Patent Application Publication
(10) Pub. No.: US 2015/0248717 A1
(43) Pub. Date: Sep. 3, 2015

(54) COMMERCIAL SERVICE SUPPORTING SYSTEM

(71) Applicant: Jonathan CHEN, Taichung (TW)

(72) Inventor: Jonathan CHEN, Taichung (TW)

(21) Appl. No.: 14/193,010

(22) Filed: Feb. 28, 2014

(51) Int. Cl. G06Q 30/06

(52) U.S. Cl. CPC G06Q 30/0625

(57) ABSTRACT

A commercial service supporting system is disclosed. The commercial service supporting system includes a smart phone, a supporting server and a product server. By using application software (APP) installed in the smart phone, connection between the smart phone and the supporting server over internet is achieved. The supporting server can interactively provide services to the smart phone user. The system can save lots cost since telephone call communication is replaced by internet communication.

### FIELD OF THE INVENTION

The present invention relates to a commercial service supporting system. More particularly, the present invention relates to a commercial service supporting system which provides commercial services to end-users with communication over mobile internet.

### BACKGROUND OF THE INVENTION

Commercial service is very important for all product suppliers. Before and when end-users buy a desired product, they might not know thoroughly how to use this product. Even a detailed user manual is provided, effect is limited. Sometimes, end-users have to collect the user manual, guarantee card, service phone number, product serial number, etc., in the moment using the product. They need a quick way to start using the product. This might not be an easy task a paper can do. It is worse that people might carelessly injure the product, or even cause damage to the surroundings. An in-time teaching for correct operation or treatment for the damage is needed.

Conventionally, almost all product suppliers will have their resellers or sales as the contact window to settle the troubles or provide necessary services. However, for those end-users who live far away from the store they brought the product, another traffic come back and forth for trouble shooting or studying how to use the produce is very inconvenient. Hence, toll free service call is pervaded. End-users can make a free phone call provided somewhere on the package or manual of the product to the product supplier or their agent. An interactive communication can fulfill end-users' requests and let them know how to use the product or settle troubles of the product. However, if the product is damaged after use or dead on arrival, the conversation will be long and a call-back service might be provided.

Usually, a service staff answering the toll free service call needs to swiftly clarify the condition of the product, including what kind of model the end-user brought, sales records, requirement the end-user needs, what kind of the damage the product might be, etc. After an initial inquiry and confirmation, the service staff is able to provide corresponding services before he can hang up the phone call. Basically, a detailed and comprehensive explanation is necessary. Since the product supplier finally pay for the telephone bill, it is conceivable that the toll free service call is a significant burden in business operation. Labor cost (service staff) is an associated cost.

With the development of technologies, it is a good news that mobile internet can provide solution to reduce the cost mentioned above. Because new mobile phone mobile communication technology standards (the third or fourth generation) can support amended mobile web access, IP telephony, gaming services, high-definition mobile TV, video conferencing, 3D television, and even cloud computing. By applying a proper system, product suppliers don't have to bear much cost on commercial service.

Meanwhile, smart phones are also another help for operation of toll free service call. Smart phones may include Global Positioning System (GPS) and accelerometer for positioning. All of them support Wi-Fi for communication over internet. Most important of all, smart phones carry at least a camera module. With a proper APP, object recognition is available. These new technologies boost human connection as well as information exchange.

Hence, although the requirement of reducing cost on commercial service is still desired, it doesn't have to long for a great achievement thereof with the aid of the present invention.

### SUMMARY OF THE INVENTION

Conventionally, commercial service of toll free call consumes lots of cost on telephone bills as well as labor cost. Therefore, a suitable system operates to reduce the costs mentioned above is desired.

According to an aspect of the present invention, a commercial service supporting system is provided. The commercial service supporting system includes: a smart phone, installed with an application software (APP), having an information fetching unit for fetching a product information data from a product; a supporting server, connected with the smart phone over internet, comprising: a product database, stored with general information of the product and a product recognizing data of the product; a product recognizing module, for receiving the product information data from the smart phone, recognizing the product by matching the product information data with the product recognizing data; and a service module, linked with the APP through the smart phone, for providing a plurality of service options shown on an interface of the APP, receiving an selected service option from the APP and initiating a transfer call for the smart phone user if the selected service option is requested, wherein the service options are used to provide product-related messages or trouble-shooting; and a product server, wiredly or wirelessly connected with the supporting server, for receiving the transfer call and assigning a service staff to communicate with the smart phone user.

Preferably, the product information data is a matrix barcode, one-dimensional barcode, a voice made by the product, at least one image of the product or a physical or chemical characteristic of the product.

Preferably, the general information includes model number, serial number, date code, software version, customer registration data, sale date, seller information, and maintenance records.

Preferably, the product recognizing data is matrix barcode, one-dimensional barcode, a voice made by the product, at least one image of the product or a physical or chemical characteristic of the product.

Preferably, the APP can match the product information data with the product recognizing data by acquiring the product recognizing data from the product database and the product recognizing module doesn't process matching the product information data with the product recognizing data.

Preferably, the information fetching unit is a camera module, a microphone or any device capable of fetching a physical or chemical characteristic in the smart phone.

Preferably, the transfer call is an IP phone call or a telephone call.

Preferably, the IP phone call conforms to Session Initiation Protocol (SIP).

Preferably, the service option includes download service, part acquisition service, online transfer call to call center service and call back service.

Preferably, the supporting server informs the product server about the call back service and the product server assigns a service staff to make a call to the smart phone user.

Preferably, the call from the service staff to the smart phone user is an IP phone call or other telephone call.

Preferably, the download service includes download of user manual, trouble-shooting manual, updated software or updated firmware, wherein the updated software can be downloaded and installed to the product.

Preferably, the download service is provided from the supporting server or the product server.

Preferably, the product server informs a part service center to offer parts to fulfill the part acquisition service.

By using the APP installed in the smart phone, connection between the smart phone and the supporting server over internet is achieved. The supporting server can interactively provide services to the smart phone user. The system can save lots of cost since telephone call communication is replaced by internet communication. The end-user also doesn't have to look for phone number to call. With identifying the product, services can be easily and fast obtained. To both product supplier and end-user, the present invention provides a win-win scenario.

### BRIEF DESCRIPTION OF THE DRAWINGS

FIG. 1 illustrates a commercial service supporting system according to the present invention.

FIG. 2 shows a smart phone with an application software icon on a touch screen.

FIG. 3 illustrates a camera module of the smart phone.

FIG. 4 shows a menu of an interface of the application software.

FIG. 5 illustrates functions of a supporting server according to the present invention.

### DETAILED DESCRIPTION OF THE PREFERRED EMBODIMENTS

The present invention will now be described more specifically with reference to the following embodiments.

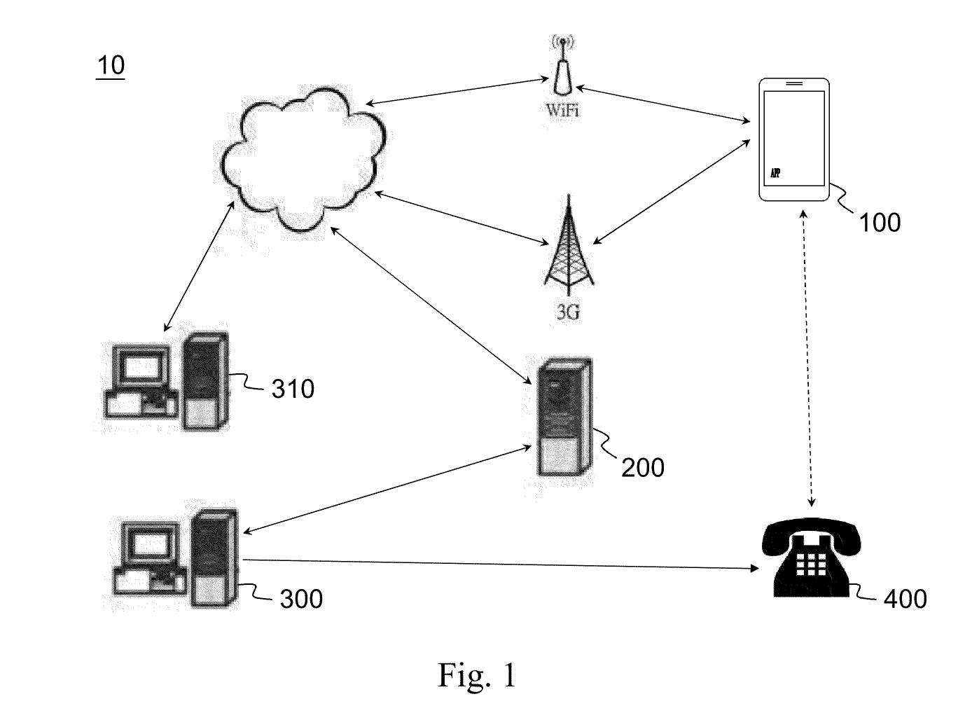

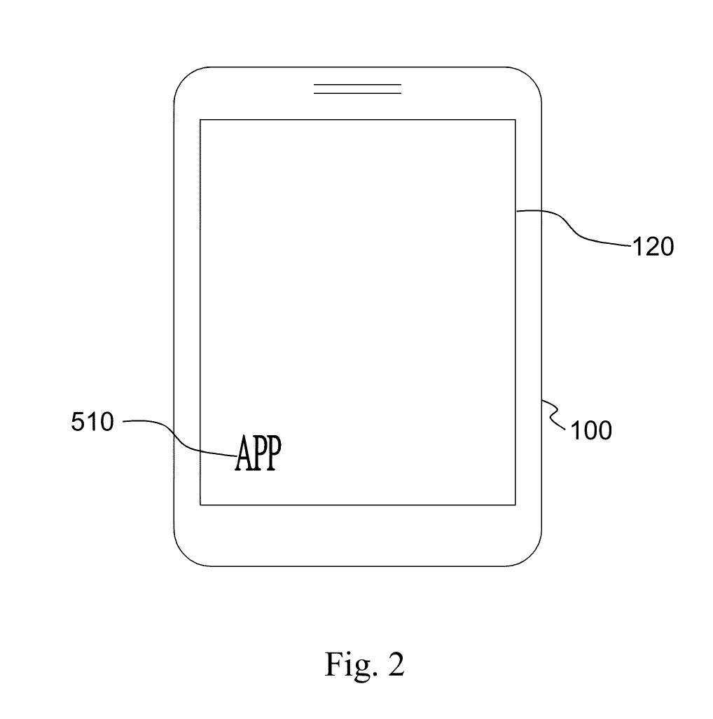

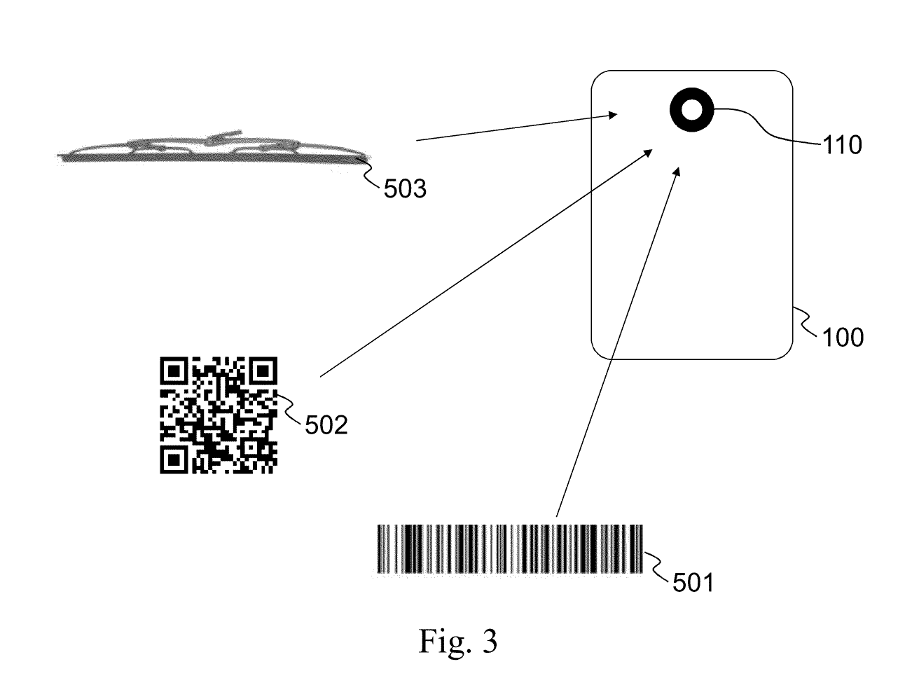

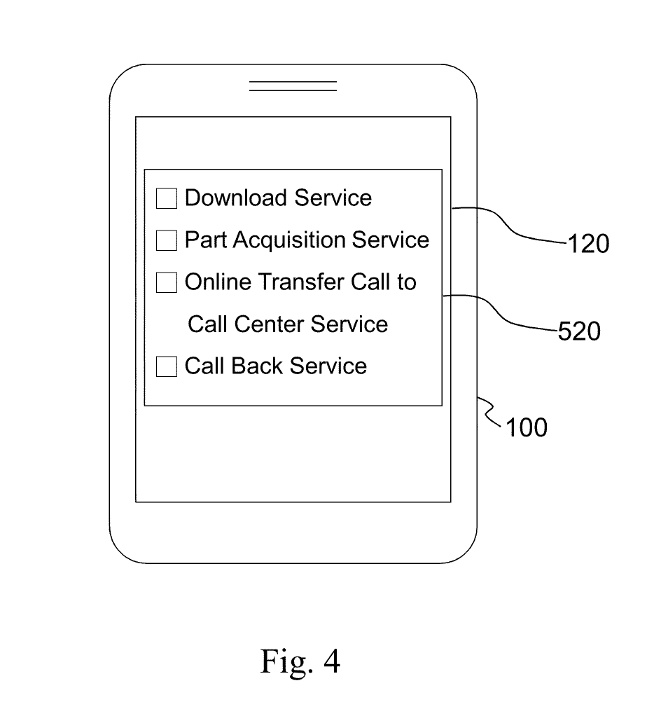

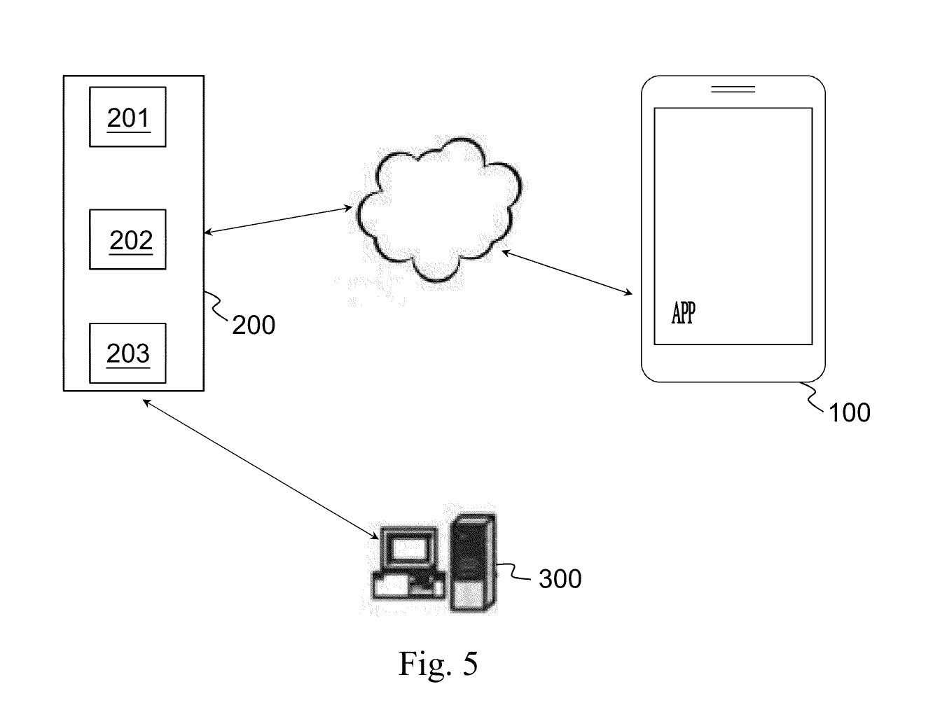

Please refer to FIG. 1 to FIG. 5. FIG. 1 illustrates a commercial service supporting system according to the present invention. FIG. 2 shows a smart phone with an application software icon on a touch screen. FIG. 3 illustrates a camera module of the smart phone. FIG. 4 shows a menu of an interface of the application software. FIG. 5 illustrates functions of a supporting server according to the present invention.

A commercial service supporting system 10 is illustrated in FIG. 1. The commercial service supporting system 10 includes a smart phone 100, a supporting server 200 and a product server 300. The smart phone 100 can connect with the internet via Wi-Fi or 3G (third generation of mobile phone mobile communication technology standards), further linking to the supporting server 200. 4G or higher specification is applicable. It is notable that some other electronic products, such as tablets, which has the same functions as smart phones can be deemed as the smart phone 100 applied in the present invention.

Please refer to FIG. 2, the smart phone 100 is installed with an application software (APP) 510. The APP 510 is shown as an icon on a touch screen 120 of the smart phone 100. When the smart phone 100 user touches the icon of the APP 510, the APP 510 initiates to function. In this embodiment, the APP 510 is downloaded from a product supplier server 310 after the product was registered online to the product supplier server 310. The APP 510 can be installed anytime as long as it is ready before customer requests come up.

A menu 520 (shown in FIG. 4) will come up. Then, the smart phone 100 user can communicate with the supporting server 200 via the menu 520. The smart phone 100 has an information fetching unit which can fetch a product information data from a product. In this embodiment, the information fetching unit is a camera module 110. The camera module 110 can be installed in the front side or the back side of the smart phone 100. It can take some specific images as the product information data. For example, the camera module 110 can take photos of a one-dimensional barcode 501 (e.g., EAN barcode) which records a model number, serial number and date code of the product on the package of product. It can also take photos of a matrix barcode 502 (e.g., QR code) which has seller information with the same information as the one-dimensional barcode 501. The matrix barcode 502 is printed on a sticker (not shown) on product. The camera module 110 can take photos of the product. In this embodiment, the product is a wiper 503. The one-dimensional barcode 501, matrix barcode 502 and images of the wiper 503 are all product information data according to the present invention.

Of course, the camera module 110 can also take a video of the product. The video can be considered as a combination of sequential “images”. Both the image and video can be used to identify the product. One image can be seen as a portion of a video to be taken. A microphone in the smart phone 100 can be another information fetching unit. The microphone is able to record a voice made by the product. The voice can be a feature to identify the product. It can be used as the product information data. More generally, a physical or chemical characteristic of the product can be deemed as the product information data. For example, one physical characteristic may be temperature measured from the product and one chemical characteristic may be a specified chemical component in the product (processed food). Thus, any device capable of fetching the physical or chemical characteristic in the smart phone 100 can be used as the information fetching unit.

Please see FIG. 5. Functions and operation of the supporting server 200 are further described. The supporting server 200 is connected with the smart phone 100 over internet. It includes a product database 201, a product recognizing module 202 and a service module 203. The product database 201 stores general information of the wiper 503 and a product recognizing data of the wiper 503. The general information includes model number, serial number, date code, software version, customer registration data, sale date, seller information, and maintenance records. Other information which is used by a specified product in another embodiment can also be one of the general information. In accordance with the product information data, the product recognizing data can be matrix barcode, one-dimensional barcode or images of the wiper 503. In this embodiment, a stored matrix barcode is used as the product recognizing data. If a video of the wiper 503 is used as the product recognizing data, there should be an identifying module (not shown) to check if one video from the smart phone 100 refers to the same wiper 503 as the product recognizing data indicates. Of course, if a voice made by a product is used as the product recognizing data, the identifying module must have to know if a voice from the smart phone 100 is the voice made by the product. Corresponding to the product information data, the product recognizing data can also be a physical or chemical characteristic of the product as long as it can be stored in form of digital information.

The product recognizing module 202 receives the product information data from the smart phone 100. It can recognize the wiper 503 by matching the matrix barcode 502 (product information data) with the stored matrix barcode (product recognizing data). If the two barcodes are identical, it means the wiper 503 is the one that the general information in the product database 201 describes. The product recognizing module 202 identifies the wiper 503. It should be noticed that matrix barcodes exist in form of digital signals. The product recognizing module 202 just compares the digital signals transformed from the matrix barcode 502 with the data in the product database 201. The APP 510 has the function to cut the barcode 502 image from a photo and transform the matrix barcode 502 into digital signal, and then the smart phone 100 sends them to the supporting server 200.

In another embodiment, a stored one-dimensional barcode is used as the product recognizing data. The APP 510 should cut the one-dimensional barcode 501 image and transform the one-dimensional barcode 501 into digital signals. The smart phone 100 sends the digital signals to the supporting server 200. In still another embodiment, stored images are used as the product recognizing data. The product recognizing module 202 is able to compare the photo with the stored images to identify if the one shown on the photo is exactly one of the stored images.

For the commercial service supporting system 105, the APP 510 can also play the role as the product recognizing module 202. The APP 510 can be further programmed to have image matching function software-defined. Then, the APP 510 matches the product information data with the product recognizing data by acquiring the product recognizing data from the product database 201. Now, the product recognizing module 202 doesn't process matching the product information data with the product recognizing data. It is a local recognition means on the smart phone 100 side.

After the wiper 503 is recognized and identified by the product recognizing module 202 or the APP 510, the service module 203 functions to provide services. The service module 203 is linked with the APP 510 through the smart phone 100 to provide a number of service options. The service options are shown on a menu 520 of the APP 510. Please refer to FIG. 4. The APP 510 might have many other menus. FIG. 4 shows just one of them. The menu 520 shows the service options: download service, part acquisition service, online transfer call to call center service and call back service. The service options are used to provide product-related messages or trouble-shooting services. The smart phone 100 user can touch any service he wants on the touch screen 120 and the smart phone 100 will send the selected service option to the supporting server 200 via internet. The service module 203 will receives the selected service option from the APP 510 and provide services accordingly. For example, the service module 203 downloads a user manual of the wiper 503 to the smart phone 100 when the service option of download service is selected. Or the service module 203 initiates a transfer call for the smart phone 100 user to the product server 300 if the selected service option is transfer call to call center service. The phone call can be an IP phone or a telephone call if only it is available. In this embodiment, IP phone call conforms to Session Initiation Protocol (SIP) is applied. According to the technology nowadays, a three-way call can also be available to involve the service module 203 in the loop of communication so that some key points in the communication can be recorded.

More specifically, the download service might include download of user manual and trouble-shooting manual. In another embodiment where the product is a digital camera rather than a wiper, updated software or updated firmware can be downloaded. The updated software and updated firmware can be downloaded and installed directly to that digital camera via a communication cable linked to the smart phone 100 or a laptop computer.

It is obvious that all services of the service options should be first treated by product suppliers over phone. Comparing the cost using IP phone and APP with that using telecommunication lines, benefits of the present invention are significant.

The product server 300 is wiredly or wirelessly connected with the supporting server 200. The supporting server 200 informs the product server 300 about the call back service. The product server 300 receives the transfer call and assign a service staff to communicate with the smart phone 100 user or make another call (IP phone call or telephone call via a telephone 400) to the smart phone 100 user, so that further diagnose on the problem issues of the wiper 503 can be processed. The service staff may also start diagnosing the problem issues for the smart phone 100 user after picking up the transfer call from the supporting server 200 without making an extra call. Comparing with a toll free call that bills to the service side, an IP phone call or telephone call costs much less.

It should be emphasized that the download service can be provided from the supporting server 200 or the product server 300 depending on operation of the product supplier. For some product suppliers, the supporting server 200 and the product server 300 are combined as one. The product server 200 informs a part service center (not shown) to offer parts to fulfill the part acquisition service. The product server 200 can also inform a call back center (not shown) to call back the wiper 503. Although all the jobs are done by human beings, the commercial service supporting system 10 can provide a control service in case much unnecessary labor efforts (service staffs deal with toll free calls) and reduce operation cost. With operation of commercial service supporting system 10, numerous products and related commercial services can be achieved on line synchronously, not only the wiper 503.

Because many new technologies are built in the smart phone 100, some of them can assist the application of the present invention. For example, the APP 510 can link to a Global Positioning System (GPS) module in the smart phone 100. It is able to obtain where the smart phone 100 user is located. The supporting server 200 can collect more information about the user before communication starts. It also helps operators of the supporting server 200 or the product server 300 analyze customer requirements or complains. Of course, the system can not only work after-sales, it can be applicable to pre-sales. Services provided can be changed as providing product related information, such as product specifications, launching schedule or price.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A commercial service supporting system, comprising:
a smart phone, installed with an application software (APP), having an information fetching unit for fetching a product information data from a product;
a supporting server, connected with the smart phone, comprising:
a product database, stored general information of the product and a product recognizing data of the product;
a product recognizing module, for receiving the product information data from the smart phone and recognizing the product by matching the product information data with the product recognizing data; and
a service module, linked with the APP through the smart phone, for providing a plurality of service options shown on an interface of the APP, receiving an selected service option from the APP and initiating a transfer call for the smart phone user if the selected service option is requested, wherein the service options are used to provide product-related messages or trouble-shooting services; and
a product server, wiredly or wirelessly connected with the supporting server, for receiving the transfer call and assigning a service staff to communicate with the smart phone user.

2. The commercial service supporting system according to claim 1, wherein the product information data is a matrix barcode, a one-dimensional barcode, a voice made by the product, at least one image of the product or a physical or chemical characteristic of the product.

3. The commercial service supporting system according to claim 1, wherein the general information comprises model number, serial number, date code, software version, customer registration data, sale date, seller information, and maintenance records.

4. The commercial service supporting system according to claim 1, wherein the product recognizing data is a matrix barcode, a one-dimensional barcode, a voice made by the product, at least one image of the product or a physical or chemical characteristic of the product.

5. The commercial service supporting system according to claim 1, wherein the APP can match the product information data with the product recognizing data by acquiring the product recognizing data from the product database and the product recognizing module doesn't process matching the product information data with the product recognizing data.

6. The commercial service supporting system according to claim 1, wherein the information fetching unit is a camera module, a microphone or any device capable of fetching a physical or chemical characteristic in the smart phone.

7. The commercial service supporting system according to claim 1, wherein the transfer call is an IP phone call or a telephone call.

8. The commercial service supporting system according to claim 1, wherein the IP phone call conforms to Session Initiation Protocol (SIP).

9. The commercial service supporting system according to claim 1, wherein the service option comprises download service, part acquisition service, online transfer call to call center service and call back service.

10. The commercial service supporting system according to claim 9, wherein the supporting server informs the product server about the call back service and the product server assigns a service staff to make a call to the smart phone user.

11. The commercial service supporting system according to claim 10, wherein the call from the service staff to the smart phone user is an IP phone call or other telephone call.

12. The commercial service supporting system according to claim 9, wherein the download service comprises download of user manual, trouble-shooting manual, updated software or updated firmware, wherein the updated software can be downloaded and installed to the product.

13. The commercial service supporting system according to claim 9, wherein the download service is provided from the supporting server or the product server.

14. The commercial service supporting system according to claim 9, wherein the product server informs a part service center to offer parts to fulfill the part acquisition service.
